(19) United States
(12) Patent Application Publication
(10) Pub. No.: US 2006/0038029 A1
(43) Pub. Date: Feb. 23, 2006

(54) Sprinkler system for railway vehicles

(75) Inventors: Thomas Rummig, Vienna (AT); Peter Penz, Ganserndorf (AT); Fritz Leiker, Vienna (AT); Christian Lebeda, Vienna (AT)

Correspondence Address: MONTE & MCGRAW, PC, 4092 SKIPPACK PIKE, P.O. BOX 650, SKIPPACK, PA, 19474, US

(73) Assignee: Siemens Transportation Systems GmbH & Co KG, Vienna (AT)

(21) Appl. No.: 11/220,481

(22) Filed: Sep. 7, 2005

(30) Foreign Application Priority Data
Mar. 15, 2004 (WO) PCT/AT04/00090
Mar. 19, 2003 (AT) A 442/2003

(51) Int. Cl. B67D 5/08; A62C 13/62; F23D 14/28; A62C 13/66

(52) U.S. Cl. 239/71; 239/302; 239/337; 239/72

(57) ABSTRACT

A sprinkler system for rail vehicles (SFZ) with at least one liquid container (FBH), which can be connected via a pressure medium line (DML) with a pressure medium container (DMB) and which can be placed under pressure, and with a number of thermally triggerable sprinkler nozzles (SDF, SDD) that are connected with the liquid container via a liquid line (FLL), where in the pressure medium line (DML) between the pressure medium container (DMB) and the liquid container (FBH), there is connected an electromechanical alarm valve (AVE) that is controlled by a fire alarm system (BMA), which alarm valve is closed during routine operation but which is opened in case of an alarm, so that in case of an alarm, the liquid container (FBH) and the liquid line (FLL) leading to the sprinkler nozzles will be pressurized.

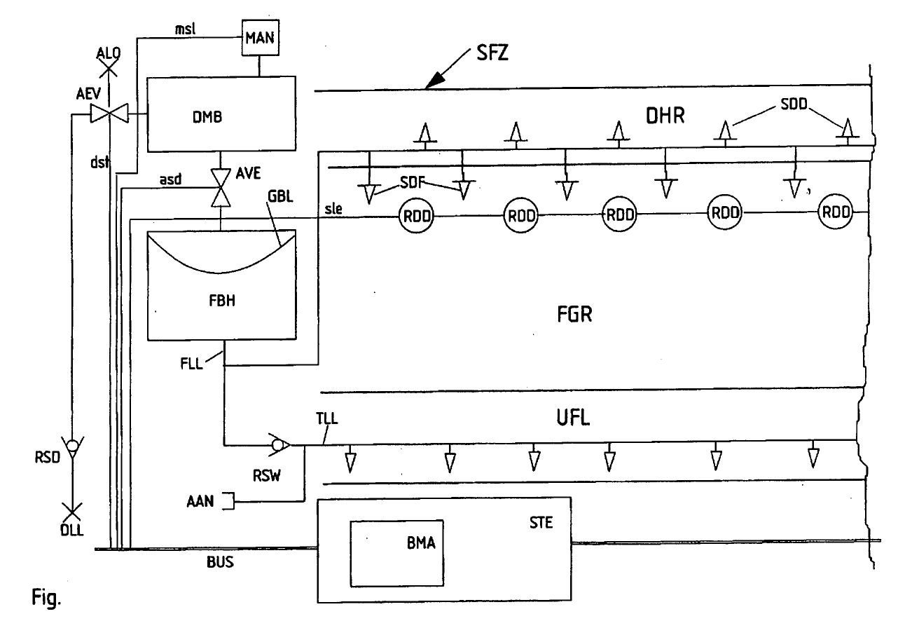

### CROSS-REFERENCE TO RELATED APPLICATIONS

This application claims the benefit of PCT Patent Application No. PCT/AT2004/000090 filed Mar. 15, 2004, which in turn claims priority from Austrian Patent Application No. A 442/2003 filed Mar. 19, 2003.

### FIELD OF THE INVENTION

This invention relates to a sprinkler system for rail vehicles with at least one liquid container that via a pressure medium can be connected with a pressure medium container and can be pressurized and with a number of thermally triggerable sprinkler nozzles that are connected with the liquid container via a liquid line.

### BACKGROUND OF THE INVENTION

Sprinkler systems are increasingly employed also in rail vehicles in order to extinguish any fires that might break out or at least to check them. When known thermally triggerable sprinkler heads are used, the system or parts thereof are filled with water that is constantly under pressure. If the temperature at the release, for example, a glass ampule of a sprinkler head, exceeds a certain value, for example, 90° C., then, for example, the ampule breaks and releases the sprinkler outlets. A system that is constantly under pressure entails various disadvantages, for example, the release of sprinkler nozzles as a result of vandalism. This is frequently encountered in railroads or subways; his is a problem that hardly plays a role, for example, in department stores and public buildings.

It is also known that fire-extinguishing media, for example, water, when necessary, that is to say, in case of a release, for example, by smoke detectors or in case of manual release by electrically operated pumps, are transported to the sprinkler nozzles. The power supply is not secured, especially in case of a fire. In case of a fire with or due to mechanical damage to the rail vehicle, both the power supply and the compressed air supply can fail—a circumstance that must not be disregarded in designing sprinkler systems.

One object of the invention is to create a sprinkler system that will guarantee the maximum possible reliability in terms of function coupled with simple maintenance and vandalism tolerance.

### BRIEF SUMMARY OF THE INVENTION

This problem is solved with a sprinkler system of the kind mentioned initially where, according to the invention in the pressure medium line between the pressure medium container and the liquid container, there is connected an electromechanical alarm valve that is controlled by a fire reporting system, which alarm valve is closed during routine operation, but which in case of an alarm is opened, so that in case of an alarm, the liquid container and the liquid line leading to the sprinkler nozzles will be placed under pressure.

As a result of the present invention, one can make sure that the sprinkler system, of course, in case of alarm, will be immediately ready for action but will not have any pressure in it, which results in advantages to the effect that vandalism on sprinkler nozzles will not result in water damages, that maintenance work is simplified, and that corrosion and material wear and tear due to pressure impact in the sprinkler system will be prevented.

In an extremely practical embodiment, it is provided that the pressure medium container is connected via at least one return valve to the pressure medium supply of the rail vehicle. In that way, a compressed air drop, for example, due to damage in a compressed air line, cannot endanger the operation of the system.

It is furthermore advantageous in terms of simple maintenance and handling when, between the return valve and the pressure medium container, there is a manually and electrically operable feed, shutoff and ventilation valve.

If the liquid line is connected via a return valve to a lower dry extinguishing line with an outside connection, then it is possible as the train is at a halt in case of a fire to provide fire-extinguishing water from the outside, as a result of which the fire can also be checked in the underflow area.

Furthermore, it is advantageous when the liquid line leads both to the sprinkler nozzles for the hollow filler space of the vehicle and to the sprinkler nozzles for the passenger compartment or the interior compartment. As a result, in addition to the passenger compartment, one can also cover the hollow filler space that cannot be observed; here it is practical when the sprinkler nozzles can be triggered for segments of the rail vehicle, for example, the hollow filler space, in case of a temperature higher than the temperature that would trigger the sprinkler nozzles for the passenger compartment and interior compartment. These segments, in keeping with the basic intention, usually display higher temperatures than the ambient temperature of the vehicle.

### BRIEF DESCRIPTION OF THE DRAWINGS

The accompanying drawings, which are incorporated herein and constitute part of this specification, illustrate the presently preferred embodiments of the invention, and, together with the general description given above and the detailed description and additional advantages given below, serve to explain the features of the invention. In the drawings:

The only FIGURE is a diagram showing a sprinkler system according to the invention.

### DETAILED DESCRIPTION OF THE INVENTION

In the drawings, like numerals indicate like elements throughout. In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

The diagram in the FIGURE illustrates about half of a rail vehicle SFZ, where one can visualize the rail vehicle SFZ as being continued in mirror-image fashion to the right in the same mode. Provided in the rail vehicle SFZ is at least one liquid container FBH, which via a pressure medium line DML and an alarm valve is connected to a pressure medium container DMB. To separate the pressure medium, generally compressed air, and the water in the liquid container FBH, there is provided in the known manner a rubber bladder GBL or the like in the liquid container FBH.

A liquid line FLL leads from the liquid container FBH to the sprinkler nozzles SDF in the ceiling filler area of a passenger compartment FGR as well as to the sprinkler nozzles SDD in the hollow filler space in the ceiling above the passenger compartment. The term “passenger compartment” naturally does not rule out the possibility that the system might in a similar manner be provided for passenger coaches and traction vehicles of any kind and purpose (for example, freight cars), which then do not have any “passenger compartment” but rather an interior compartment, a loading surface or an area for the transportation of persons and goods.

Furthermore, the liquid line leads to a dry extinguishing line TLL in the underfloor area of rail vehicle RSW via a return valve. This dry extinguishing line TLL has spray or sprinkler nozzles and, if necessary, can extinguish or check a fire in the underfloor air of the rail vehicle SFZ. The dry extinguishing line TLL is provided with an outside connection AAN, for example, with a so-called “C-pipe” connection.

The sprinkler nozzles SDF for the passenger compartment FGR and SDD for the ceiling filler space DHR can be triggered thermally, that is to say, for example, in the known manner, they are provided with a glass ampule, which will burst at a certain temperature and which will release the sprinkler outlet of the corresponding nozzle. In view of the heat distribution, for example, in a fire in the inside of the passenger compartment of a rail vehicle, the sprinkler nozzles SDF for the passenger compartment FGR are usually triggered earlier, that is to say, at temperatures of between 70 and 100° C. when compared to the sprinkler nozzles SDD for the ceiling filler space DHR that are triggered, for example, only at temperatures of 200 to 250° C. Depending on climatic conditions, the ceiling filler space is often subjected to severe solar radiation, which also under normal circumstances can result in high temperatures of 60 to 70° C. so that a release at lower temperatures would cause unnecessary damage.

The pressure medium container DMB is connected via a manually and electrically operable feed, shutoff and ventilation valve AEV and via a return valve RSD with the compressed air line DLL of the rail vehicle. When valve AEV is correspondingly switched around, compressed air can flow out of the pressure medium container DMB via an outlet opening ALO.

Alarm valve AVE is connected via a control line with a fire alarm system BMA or, quite generally, with a control, whereby mostly a vehicle bus BUS will contain the various control lines. Valve AEV is also connected to the vehicle bus BUS via a control line dsd.

Smoke detectors RDD are provided at suitable places in the known manner in the internal compartment or the passenger compartment FGR of the rail vehicle SFZ and they are connected via a sensor line sle and the bus BUS with the fire alarm system BMA or the control STE. The pressure medium in the pressure medium container DMB is acquired by a pressure gauge and is relayed via a corresponding reporting line msl and the bus BUS to the control SDE.

As mentioned earlier, the FIGURE shows only one half of the rail vehicle SFZ and the “right” half of the vehicle, not shown in the drawing, is designed especially in mirror-image fashion, whereby generally the half that is not shown also contains a liquid tank FBH and a pressure medium tank DMB with corresponding valves, although it need not necessarily so contain them.

The basic function of the sprinkler system according to the invention will be explained below. In case of the so-called outfitting of a train, the alarm valves AVE of the individual passenger coaches or rail vehicles SFZ are triggered via the smoke detectors RDD of the passenger compartment and possibly via those that are also in the ceiling filler space DHR and thus block the connection between the pressure medium container DMB and the liquid container FBH. This control works in the known manner for safety reasons via a safety loop, including a fire reporting system BMA or the control STE. After the alarm valves AVE have been triggered, compressed air feed valves, likewise not shown here, are triggered via the control equipment of the train and the pressure medium container DMB is impacted with compressed air via the return valve RSD. The control and fire alarm system SDE and BMA are so set up that there will be no compressed air impacting when the smoke detectors or the alarm valves do not work.

If in case of smoke generation in the passenger compartment or in the ceiling filler space a smoke detector RDD signals a fire, then the smoke safety loop of the particular passenger coach is interrupted and the alarm valve AVE is opened. This valve is so constructed that it is open in the currentless state, but that it is closed when there is current in it. Compressed air reaches the liquid container FBH as a result of the opening of the alarm valve AVE, and via the rubber bladder GBL, it pressurizes the liquid contained therein, generally water with an addition of antifreeze agents and anticorrosive substances. If a sprinkler nozzles SDF, SDD is triggered by the rupture of its glass ampule, then water is sprayed in its area in order to extinguish or check a fire. If the train comes to a halt in case of a fire, then via the outside connection AAN, auxiliary personnel, for example, the fire department, can pump water to the dry extinguishing line TLL and also to the sprinkler nozzles SDF and SDD, in particular, in order to extinguish or check a fire that has broken out in subassemblies in the underfloor area or to achieve a cooling effect.

When a train is taken out of service, the control can make sure that the system will remain active for a certain period of time, e.g. 40 minutes, in other words, that the alarm valve AVE will remain on and that the smoke alarms RDD will also be active. Only the pressure medium resupply for the pressure medium container DMB, which is so designed that sufficient air will be available for fire extinction, will be turned off. The sprinkler system is also flooded if the smoke alarm is set off during those, for instance, 40 minutes.

Only after that span of time, for example, after 45 minutes, the compressed air feed valve AEV is switched to ventilation exhaust and the pressure medium container DMB is emptied. After another 10 minutes or so, the alarm valves AVE can then be turned off to prevent the batteries of the rail vehicle or the train from being subjected to unnecessary load.

The structure of the sprinkler system is so designed that the train's control equipment is needed for the outfitting of the system so that the system can be triggered and can be closed down even without any process control equipment. The operation of the sprinkler system is guaranteed during the subsequent span of time, for example, the previously mentioned 40 minutes, even if the train driver might possibly stop the train at the next station in case of a fire.

The sprinkler system continues to operate as a result of the return valve RSD also when the train's compressed air supply is damaged so long as there is no ventilation exhaust via the shutoff and ventilation exhaust valve AEV. Due to the characteristics of the alarm valve AVE, any possible power failure will by the same token lead to the flooding of the fire-extinguishing lines, whereby a switch can be provided for proper attendance in a workshop mode, which switch will prevent a filling with compressed air in this case. In general, the various switching states of the valves and the pressure in the pressure medium container are checked for plausibility and a failure or a response of the system is indicated to the driver on a trouble or operating report display, provided the process technology of the train is not hit by the fire or the train driver has not switched to emergency run.

The water is changed about twice a year for the purpose of maintaining the sprinkler system and it is provided with an antifreeze or anticorrosion protection and antibacterial agents. The valves are also checked for proper operation and the sprinkler heads are checked for damage to their glass ampules.

In addition to a simple structure, the invention-based sprinkler system is distinguished by extremely reliable operation, which, due to the flooding of the fire-extinguishing lines via the alarm valve AVE only in case of fire, will prevent damage to the rail vehicle SFZ as a result of faulty release or vandalism and will minimize or prevent mechanical, corrosive and other stresses on the liquid container FBH, the liquid line FLL and the sprinkler heads due to pressure or leaking fire-extinguishing means.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A sprinkler system for rail vehicles with at least one liquid container, which via a pressure medium line can be connected with a pressure medium container and which can be placed under pressure and with a number of thermally triggerable sprinkler nozzles that are connected with the liquid container via a liquid line, characterized in that:
in the pressure medium line between the pressure medium tank and the liquid container, there is connected an electromechanical alarm valve that is controlled by a fire alarm system, which is closed during routine operation but which is open in case of an alarm, so that in case of an alarm, the liquid container and the liquid line leading to the sprinkler nozzles will be pressurized.

2. The sprinkler system according to claim 1, characterized in that the pressure medium container is connected via at least one return valve to the pressure medium supply of the rail vehicle.

3. The sprinkler system according to claim 2, characterized in that a manually and electrically operable feed, shutoff and ventilation exhaust valve is positioned between the return valve and the pressure medium container.

4. The sprinkler system according to claim 3, characterized in that the liquid line is connected via a return valve to a lower dry fire-extinguishing line with an outside connection.

5. The sprinkler system according to claim 2, characterized in that the liquid line is connected via a return valve to a lower dry fire-extinguishing line with an outside connection.

6. The sprinkler system according to claim 1, characterized in that the liquid line is connected via a return valve to a lower dry fire-extinguishing line with an outside connection.

7. The sprinkler system according to claim 6, characterized in that the liquid line leads both to the sprinkler nozzles for the ceiling filler space of the vehicle and to the sprinkler nozzles for the passenger compartment or internal compartment.

8. The sprinkler system according to claim 7, characterized in that the sprinkler nozzles for segments of the rail vehicle, for example, for the ceiling filler space, can be triggered at temperatures higher than the sprinkler nozzles for the passenger compartment or interior compartment.

9. The sprinkler system according to claim 1, characterized in that the liquid line leads both to the sprinkler nozzles for the ceiling filler space of the vehicle and to the sprinkler nozzles for the passenger compartment or internal compartment.

10. The sprinkler system according to claim 9, characterized in that the sprinkler nozzles for segments of the rail vehicle, for example, for the ceiling filler space, can be triggered at temperatures higher than the sprinkler nozzles for the passenger compartment or interior compartment.

11. The sprinkler system according to claim 1, characterized in that the sprinkler nozzles for segments of the rail vehicle, for example, for the ceiling filler space, can be triggered at temperatures higher than the sprinkler nozzles for the passenger compartment or interior compartment.
